(19) United States
(12) Patent Application Publication
(10) Pub. No.: US 2003/0224139 A1
(43) Pub. Date: Dec. 4, 2003

(54) Drop cloth

(76) Inventor: Nicholas Nociforo, Springfield, PA (US)

Correspondence Address: John S. Munday, Esquire, LAW OFFICES OF JOHN S. MUNDAY, PO BOX 423, Isanti, MN, 55040, US

(21) Appl. No.: 10/453,152

(22) Filed: Jun. 2, 2003

Related U.S. Application Data
(60) Provisional application No. 60/385,303, filed on Jun. 4, 2002.

(51) Int. Cl. B32B 3/06

(52) U.S. Cl. 428/99

(57) ABSTRACT

A drop cloth sized to cover individual items having at least an usable component and formed from a plurality of panels attached to each other to form a three dimensional drop cloth having the shape of a specific item. The cloth includes at least one removable panel positioned over the usable component to provide access to the usable component while the item is covered by the drop cloth. The remaining panels other than the removable panel may be either fixedly or removably attached to form the drop clothe The panels may be a large plurality of panels such that the drop cloth is formed by attaching less than all of the plurality. Removable panels are removably attached by a fastener such as zippers, hook and latch members, buttons and snaps. The plurality of panels are normally formed from a liquid impervious material to prevent liquid from contacting the item.

### FIELD OF THE INVENTION

This invention relates to a drop cloth for use with painting, cleaning, and other activities in which fixtures are covered. More particularly, the invention relates to a drop cloth sewn or otherwise shaped to conform to toilets and other fixtures such as those found in bathrooms, which thus permits the use of the fixture during the construction, repair or other activity in the proximity of the fixture.

### BACKGROUND OF THE INVENTION

Drop cloths are a staple item in the construction industry, used by painters, carpenters, drywallers, plumbers, handy men and women, homeowners, tile setters, wallpaper scrapers and hangers, and the like. Conventional drop cloths are large, to cover a workable area, and are very cumbersome to drape over fixtures such as toilets, sinks, bathtubs, custom furniture and the like. However, once a drop cloth covers a toilet, for example, it exposes the toilet to accidental damage when the cloth is pulled at the far end. It also renders the fixture inaccessible and thus inoperable until the entire job is completed.

It would be of great advantage in the art if a device could be provided that would permit covering individual fixtures and other household items.

Another advantage is to provide a device for covering fixtures and other household items which permits the use of the fixture while the room is otherwise covered.

Yet another advantage of the present invention would be to provide a cover for fixtures and other household items without subjecting them to potential damage

Other advantages will appear hereinafter.

### SUMMARY OF THE INVENTION

It has now been discovered that the above and other advantages of the present invention may be achieved in the following manner. The unique aspect of this invention is the use of a drop cloth that is sized to cover individual items such as toilets and other bathroom fixtures as well as other furniture, computers and the like, during work being performed in the room where the items are located.

The drop cloths of this invention are made in a shape and size suitable for covering fixtures such as toilets, sinks, bathtubs, computers and work stations, chairs, tables, other custom furniture and the like. It is contemplated that the cover itself will be formed from a material that is impervious to paint, plaster, or other debris or trash that accumulates in a room where work is being done by painters, carpenters, drywallers, plumbers, handy men and women, homeowners, tile setters, wallpaper scrapers and hangers, and the like. The material may be canvas or plastic, depending on the nature of the work, and it may also be formed from cotton or disposable plastic, or even recyclable paper if desired.

The principal feature of the device of this invention is that it is formed from a plurality of panels to provide a three dimensional shape that generally resembles the object being covered. The device may be sewn, when canvas or other materials that accept thread and needle junctions, or it may be molded. When plastics are used, the junctions may be formed by heat seat Adhesives are also within the scope of the present invention.

The material used to construct this liner may be of a range of thicknesses, since the device does not bear much load but should be strong enough to permit easy use by the worker placing the device over the fixture and the like.

Preferred are disposable plastics, such as polyethylene, polypropylene, and composite polymers having an appropriate resistance to other somewhat aggressive materials such as plaster or paint, for example. Also preferred are waxed cardboard and other construction materials that have the appropriate resistance properties as described herein.

### BRIEF DESCRIPTION OF THE DRAWINGS

For a more complete understanding of the invention, reference is hereby made to the drawings, in which:

FIG. 1 is a side elevational view showing the device of this invention in dash lines covering a fixture such as a toilet; and

FIG. 2 is a perspective view of the device of this invention, shown in position for use.

### DETAILED DESCRIPTION OF THE PREFERRED EMBODIMENT

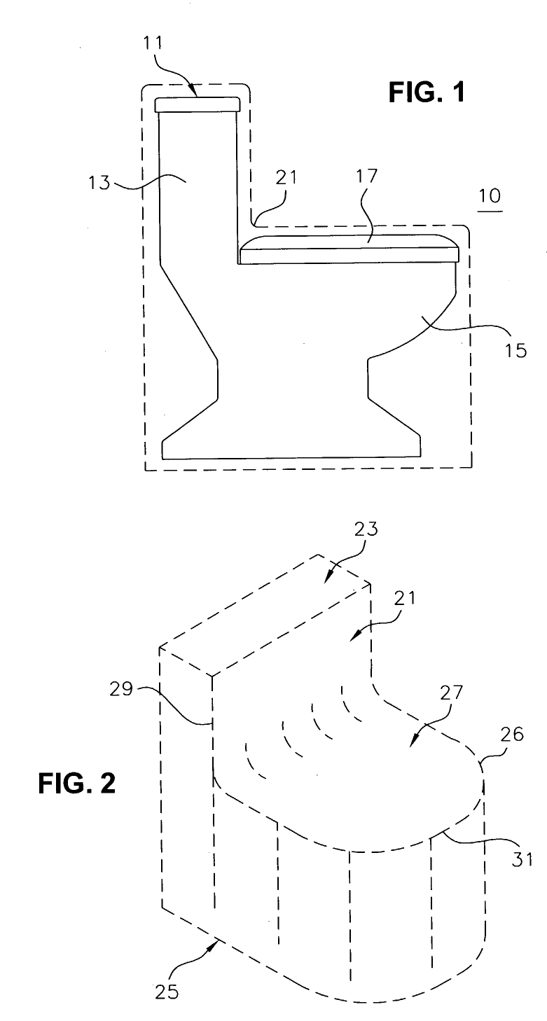

As shown in FIG. 1, the present invention, 10 generally, is intended for use with a fixture such as toilet 11, when the fixture is to be covered during painting or any of the other jobs enumerated above. Toilet 11 has a conventional shape with water closet 13 and basin 15 extending up. Toilet seat 17 is also conventional. Toilet 11 is covered by the drop cloth 21 of the present invention.

The present invention is useful for most fixtures and the like that have a standard size, it being recognized that an inventory of sizes will be desirable to cover variations in sizes and other products. The toilet 11 is used for illustrative purposes only.

In FIG. 2, drop cloth 21 includes a generally rectangular portion 23 that covers water closet 13, and further includes a lower portion 25 for covering the basin 15. Lower portion 25 may have a rounded shape 26, as shown in FIG. 2, or it may be squared off, as desired. The top 27 of lower portion 25 covers the toilet seat 17.

In one embodiment, the entire drop cloth is formed by sewing the panels from which it is made, along seams 29. In another embodiment, top 27 can be fitted with an openable seam 31, which can be fastened closed with a woven hook strip, a zipper, snaps or other means for removably fastening top 27 to lower portion 25, to permit use of the fixture without removal of the entire drop cloth 21. In yet another embodiment, the lower portion 25 is slightly larger than the basin 15, so that this portion only can be lifted up for access to the fixture, then replaced to cover the seat 17 when the user is done. In any case, because the drop cloth 21 is significantly smaller than conventional drop cloths, it can be removed during the work so that the fixture can be used, then recovered.

It is also contemplated that there be a large plurality of panels and only a portion of the large plurality are selected to create the three dimensional drop cloth of this invention.

While particular embodiments of the present invention have been illustrated and described, it is not intended to limit the invention to any specific embodiment. Specifically, the invention is not limited to any specific fixture, such as a toilet, and the various fixtures and other items listed herein are intended as exemplary rather than limiting. The dimensions and materials given are for the preferred embodiment and are not to be construed as limitations on the scope of this invention The description of the invention is not intended to limit the invention.

1. A drop cloth sized to cover individual items having at least a usable component, comprising;
a plurality of panels attached to each other to form a three dimensional drop cloth having the shape of a specific item to thereby cover said item to protect it from its environment; and
at least one removable panel being removable attached in said three dimensional drop cloth, said at least one removable panel being positioned over said usable component to provide access to said usable component while said item is covered by said drop cloth.

2. The drop cloth of claim 1, wherein the remaining panels other than said removable panel are fixedly attached to form said three dimensional drop cloth.

3. The drop cloth of claim 1, wherein all of said plurality of panels are removably attached to each other by a fastener to form said three dimensional drop cloth.

4. The drop cloth of claim 1, wherein said removable panel is removably attached to each other by a fastener to form said three dimensional drop cloth.

5. The drop cloth of claim 4, wherein said fastener is selected from zippers, woven hook strip, buttons and snaps.

6. The drop cloth of claim 1, wherein said removable panel is fixedly attached along part of its periphery to an adjoining panel and removably attached along the remainder of its periphery.

7. The drop cloth of claim 6, wherein said removable panel has four sides on its periphery and only one side is fixedly attached.

8. The drop cloth of claim 1, wherein said plurality of panels includes a large plurality of panels and said three dimensional drop cloth is formed by attaching less than all of said larger plurality, said panels being selected to proximate the shape of said item.

9. The drop cloth of claim 1, where said item is selected from toilets and other bathroom fixtures, tables, chairs and other furniture, computers, and copiers and other business equipment.

10. The drop cloth of claim 1, wherein said plurality of panels are formed from a liquid impervious material to prevent liquid from penetrating said panels to contact said item.

11. A drop cloth sized to cover individual items having at least a usable component, comprising:
a plurality of panel means for covering said item, said panel means being attached to each other to form a three dimensional drop cloth having the shape of a specific item to thereby cover said item to protect it from its environment; and
at least one removable panel means for providing access to said item, said removable panel means being removable attached in said three dimensional drop cloth, said at least one removable panel means being positioned over said usable component to provide access to said usable component while said item is covered by said drop cloth.

12. The drop cloth of claim 11, wherein the remaining panel means other than said removable panel means are fixedly attached to form said three dimensional drop cloth.

13. The drop cloth of claim 11, wherein all of said plurality of panel means are removably attached to each other to form said three dimensional drop cloth.

14. The drop cloth of claim 11, wherein said removable panel means are removably attached by fastener means for attaching said panel means to each other to form said three dimensional drop cloth.

15. The drop cloth of claim 14, wherein said fastener means is selected from zippers, woven hook strip, buttons and snaps.

16. The drop cloth of claim 11, wherein said removable panel means is fixedly attached along part of its periphery to an adjoining panel means and removably attached along the remainder of its periphery.

17. The drop cloth of claim 16, wherein said removable panel means has four sides on its periphery and only one side is fixedly attached.

18. The drop cloth of claim 11, wherein said plurality of panel means includes a large plurality of panel means and said three dimensional drop cloth is formed by attaching less than all of said larger plurality, said panel means being selected to proximate the shape of said item.

19. The drop cloth of claim 11, where said item is selected from toilets and other bathroom fixtures, tables, chairs and other furniture, computers, and copiers and other business equipment.

20. The drop cloth of claim 11, wherein said plurality of panel means are formed from a liquid impervious material to prevent liquid from penetrating said panel means to contact said item.
